(19) United States
(12) Patent Application Publication
(10) Pub. No.: US 2002/0163776 A1
(43) Pub. Date: Nov. 7, 2002

(54) Multi-supplier LCD monitor support and housing

(76) Inventors: Andrew A. Thompson, Seattle, WA (US); John L. Madera, Renton, WA (US)

Correspondence Address: Mark S. Beaufait, Esq., BLACK LOWE & GRAHAM PLLC, 816 Second Avenue, Seattle, WA, 98104, US

(21) Appl. No.: 10/135,924

(22) Filed: Apr. 29, 2002

Related U.S. Application Data
(60) Provisional application No. 60/288,250, filed on May 1, 2001.

(51) Int. Cl. G06F 1/16

(52) U.S. Cl. 361/681; 248/919; 312/7.2

(57) ABSTRACT

An apparatus is provided for supporting a display device. A bracket includes first and second substantially parallel arms arranged to receive sides of a display device therebetween for attachment thereto. A first cross member is interposed between the first and second arms, and a second cross member is interposed between the first and second arms and extends from the first cross member. The second cross member is arranged to receive a back plane of the display device for attachment thereto. A housing is removably fastened to the bracket. The housing is arranged to surround the bracket and define a window, and the visual display area of a display device attachable to the bracket is viewable within the window.

### PRIORITY CLAIM

This application claims priority from U.S. Provisional Application No. 60/288,250, filed May 1, 2001.

### FIELD OF THE INVENTION

This invention relates generally to visual displays and, more specifically, to visual display supports.

### BACKGROUND OF THE INVENTION

In many applications, visual display devices for displaying video information or other data are typically supported and housed in specialized units that protect and support the display device. Many types of units have been proposed and implemented for supporting and housing cathode ray tube (CRT) displays in many environments, including passenger aircraft. Methods of supporting CRT-based displays include retractable housings and supports, and various configurations of swivelable and tiltable trays for the CRT display. Many of these support and housing devices are limited in the types, sizes and configurations of the displays they support.

Increasingly, flat panel visual display devices are replacing CRT-based visual displays. These newer, flat panel visual display devices include liquid crystal display and plasma display devices, as well as other newer screen types. Flat panel visual display devices are often rectangular in shape and smaller than CRTs. Accordingly, multiple flat panel displays may be used in lieu of larger displays with retractable or tiltable/swiveable housings and supports. Further, different supports and housings are needed to adapt these flat panel visual display devices to their use environments. As a result, many retractable and/or tiltable/swivelable supports and housings used for CRTs are not desirable for many flat panel displays in environments where space is limited.

In aircraft and in other applications, space, viewability, and weight considerations are often key factors. However, known display supports may be bulky and heavy. In addition, known display supports may also limit access for installing and repairing flat panel visual display devices.

Therefore, there is an unmet need in the art for flat panel display support and housing devices which combine simplicity, size constraints, accessibility and weight benefits.

### SUMMARY OF THE INVENTION

The present invention provides a lightweight, compact, and uncomplicated system for supporting and housing flat panel visual display devices of various configurations and sizes from various manufacturers. The visual display support and housing device of the present invention allows configuration for use on aircraft, especially in passenger aircraft cabins.

The invention provides a bracket to receive a display device mountable thereon, and a housing removably fastenable to the bracket. The housing is arranged to surround the bracket and define a window. The visual display area of the display device is viewable within the window.

### BRIEF DESCRIPTION OF THE DRAWINGS

The preferred and alternative embodiments of the present invention are described in detail below with reference to the following drawings.

FIG. 1 is an isometric exploded view of a support bracket of the present invention;

FIG. 2 is an isometric exploded view of the support bracket of the present invention attached to a support surface;

FIG. 3 is an isometric exploded view of a removable housing of the present invention;

FIG. 4 is a side view of the support bracket and removable housing of the present invention;

FIG. 5 is a front view of the removable housing of the present invention when installed;

FIG. 6 is a side view of a detail of the removable cover of the present invention; and

FIG. 7 is a side view of another detail of the removable cover of the present invention.

### DETAILED DESCRIPTION OF THE INVENTION

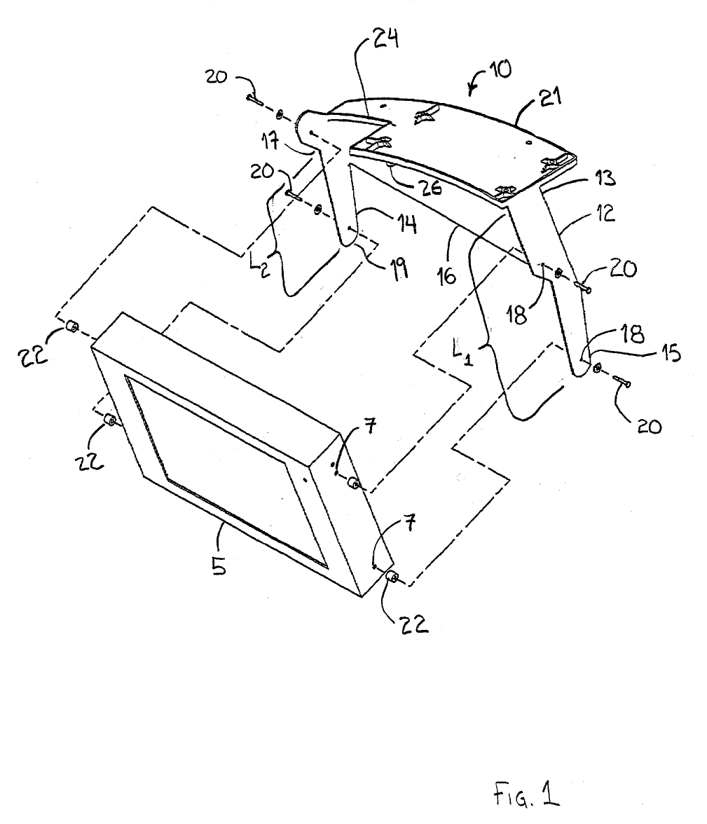

FIGS. 1, 2, and 3 are isometric, exploded drawings of an exemplary embodiment of the present invention. A flat panel display support bracket 10 is suitably covered by a removable housing 40 and is configured to attach to a surface such as to an aircraft cabin ceiling panel 60.

In FIG. 1, the support bracket 10 is shown supporting a display 5. Given by way of non-limiting example, the display 5 is suitably a flat panel visual display. The support bracket 10 includes a first bracket arm 12 and a second bracket arm 14. The first bracket arm 12 has a first end 13 and a second end 15. The second bracket arm 14 has a first end 17 and a second end 19. The first and second bracket arms 12 and 14 are laterally spaced apart from each other by a first cross member 21. The first and second bracket arms 12 and 14 are attached to the cross member 21 at the first ends 13 and 17. The first and second bracket arms 12 and 14 extend substantially parallel to each other and are arranged to mountably receive sides of the display 5 therebetween. The first bracket arm 12 has a first finite length L₁ and the second bracket arm 14 has a second finite length L₂ that is less than the first finite length L₁. It will be appreciated that different lengths L₁ and L₂ allow the display 5 to be mounted horizontally when the supporting surface (not shown) is curved or inclined. It will also be appreciated that a left-to-right mirror opposite, with L₁ less than L₂, allows the display 5 to be mounted horizontally when the supporting surface (not shown) is curved or inclined in an opposite direction. The first and second bracket arms 12 and 14 may angle forward or backward from their attachment points with the first cross member 21 at their first ends 13 and 17. The bracket arms 12 and 14 may be angled to affect the tilt of the display 5. The arms may tilt forward or backward a desired angle, such as an angle between 10 and 30 degrees from the vertical. The bracket arms 12 and 14 may also have no tilt forward or backward. Given by way of non-limiting example, as shown in FIG. 1 the bracket arms 12 and 14 tilt backward at an angle of around 15 degrees.

The support bracket 10 also includes a second cross member 16. The second cross member 16 is suitably a substantially planar surface that extends from the first cross member 21 and extends between the first and second bracket arms 12 and 14. The second cross member 16 works in concert with the first and second bracket arms 12 and 14 to support the display 5.

The display 5 is suitably attached to the support bracket 10 with a plurality of display fasteners 20. The term fastener as used herein means without limitation any suitable device to removably secure one component to another. These may include without limitation threaded screws, push pins, quick release pins, threaded bolts, wing nuts, clips, sliding tabs or other fastening devices having similar functions, as is well known in the art.

The first and second bracket arms 12 and 14 define a plurality of holes 18 that receive fasteners 20 that attach the support bracket 10 to the display 5. The holes 18 may be positioned in concert with the angle of the first and second bracket arms 12 and 14 so the display 5 tilts downward at a desired angle, such as an angle between 1 and 35 degrees from the vertical. Given by way of non-limiting example, as shown in FIG. 1 the display 5 tilts downward at an angle of around 15 degrees. A downward angle of around 15 degrees has been found to be preferable for viewing a video display mounted to the ceiling of a passenger aircraft cabin. It will be appreciated that multiple holes 18, or alternatively slots or other fastening locations and types, permit alternate embodiments of the invention to accommodate different, adaptable, or multiple viewing angles for the display 5.

It will be appreciated that the bracket 10 may take any suitable dimension and shape to permit attachment of the bracket 10 to a support surface (not shown) and to the display 5. The bracket 10 may be made of any suitable material. In one aspect of the invention, the bracket 10 is suitably made from an aluminum casting. Advantageously, an aluminum casting keeps the bracket 10 relatively light. As such, a lightweight aluminum casting is desirable for the bracket 10 when the bracket 10 will be used to support the display 5 in an aircraft. Aircraft ceiling panels can typically support a total weight of no more than 30 pounds. In one embodiment of the invention that may be desirably used in an aircraft passenger cabin, the display 5, the bracket 10, the removable housing (not shown), and the plurality of the fasteners 20 are preferably selected such that their total weight does not exceed the weight that can be supported by the ceiling panel. This avoids use of additional or special structural supports. In one presently preferred embodiment, the total weight of the bracket 10 and the display 5 combined is in a range of between around 16 to 25 pounds. Other ceiling panels may support a display 5 weighing as much as 75 pounds.

As is known, visual displays come in different sizes and configuration. As shown in FIG. 1, varying sizes of the display 5 may be accommodated by the bracket 10 through the use of a plurality of spacers 22. Given by way of non-limiting example, hollow flexible tubes are suitably used as the spacers 22 in combination with the fasteners 20. The fasteners 20 are threaded through the holes 18 in the support bracket 10, pass through the spacers 22, and in turn are threaded into sockets 7 in the display 5. It will be appreciated that depending upon the size of the display 5 in relation to the size of the bracket 10, different sizes and types and dimensions of fasteners 20, with or without spacers 22, may be used to attach the display 5 to the bracket 10. This permits the display 5 to be centered within the bracket 10, and within the removable housing (not shown) that covers the display 5 and the support bracket 10. Other suitable spacers 22 include metal or plastic tabs at each fastener 20 positioned between the bracket 10 and the display 5. Alternative spacing or attachment methods may be utilized to attach the display 5 to the bracket 10. Plates or pads may be used as spacers, or a complete holding device or sleeve sized to fit within the bracket 10 and surrounding the display 5 may suitably form a single unified spacer that connects the display 5 to the bracket 10.

As shown in FIG. 1, the bracket 10 has a bracket shoulder notch 24 that permits a corner of the display 5 to nest up inside the bracket 10 and the supporting surface (not shown). The notch 24 permits the display 5 to be nested closer against and into a curved support surface, such as a passenger aircraft ceiling. Advantageously, this conserves space utilized by the display 5, the bracket 10 and the removable housing (not shown). In the embodiment shown in FIG. 1, an upper corner of the display 5 projects up through the notch 24 when the display 5 is mounted into the bracket 10. In locations where the support surface for the bracket 10 is flat, the notch 24 is not required. The invention is not limited to aircraft interiors but may be utilized in any location where flat screen visual displays are mounted.

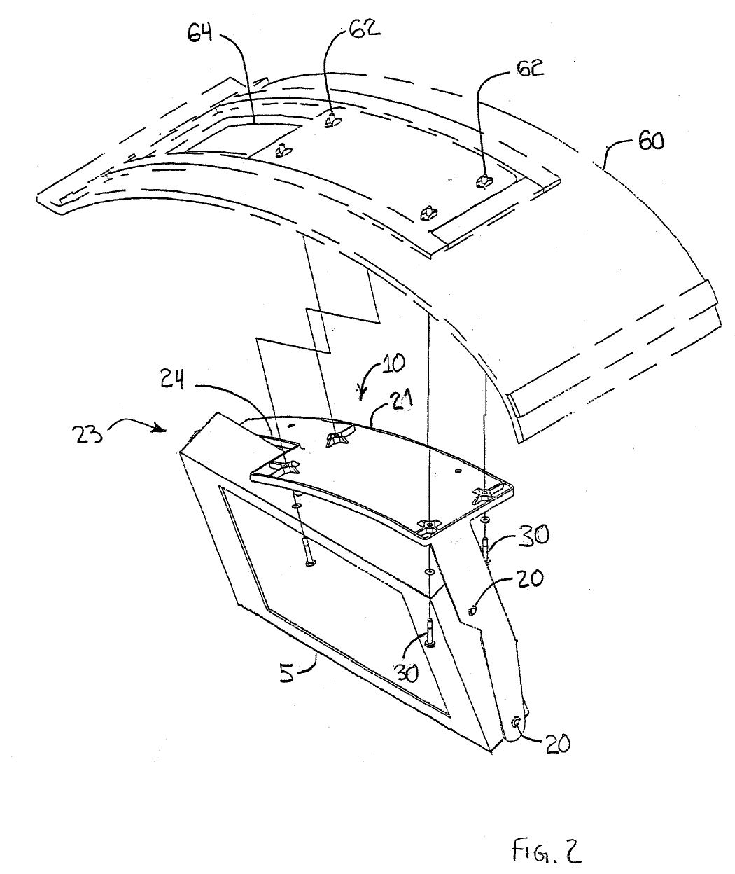

FIG. 2 is an exploded view showing the display 5 and the bracket 10 detached from its supporting surface, such as an aircraft cabin ceiling panel 60. The display 5 is mounted to the bracket 10 with display fasteners 20. The bracket 10 is mounted to the ceiling panel 60 using a plurality of mounting fasteners 30. The mounting fasteners 30 are suitably bolts with washers passing through the bracket 10 and the ceiling panel 60. The fasteners 30 are held in place by lock washers (not shown) and nut plates 62. In alternative embodiments any suitable fastener may be used.

FIG. 2 shows a corner 23 of the display 5 projecting through the bracket 10 through the notch 24. When the bracket 10 and the display 5 are mounted to the ceiling panel 60, the corner 23 projects through the ceiling panel 60 through a substantially rectangular opening 64 in the ceiling panel 60. This permits the display 5 to be mounted closely up against the ceiling panel 60, while still allowing the full viewing panel of the display 5 to be visible to a viewer.

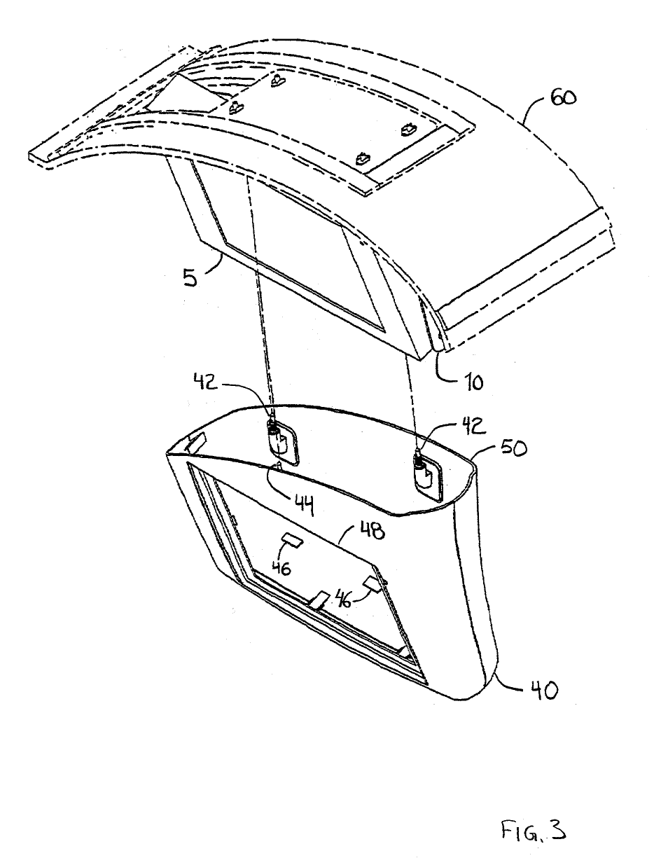

Referring now to FIG. 3, the display 5 is attached to the support bracket 10, which is fastened to the ceiling panel 60. A removable housing 40 is shown detached from the bracket 10. The housing 40 covers and protects the display 5. The display 5 and the bracket 10 are covered by the housing 40 when the housing 40 is fastened into place. In one embodiment, the housing 40 is suitably made from a polyetherimide plastic. However, it will be appreciated that other lightweight, durable materials may be used as desired.

The removable housing 40 is attached to the bracket 10 and covers the display 5 using a plurality of suitable fasteners, such as, without limitation, quick-release pin fasteners. In one embodiment, two rear housing fasteners 42 and one forward housing fastener 44 hold the housing 40.

The housing 40 includes interior standoffs 46. When the housing 40 is attached to the bracket 10 the standoffs 46 are positioned near the bottom of the back of the display 5. This supports the lower edge of the housing 40 should the housing 40 be pushed. The standoffs 46 also support the display 5. The shape of the housing 40 and the standoffs 46 may be configured to cover and rest against the back and edges of a variety of sizes of flat panel display devices. As is known, thickness of the display devices may vary by greater than 0.25 inch, and their screen size and resulting diagonal length may vary by over one inch. For example, a display device may have a diagonal display length in a range from 12 inches to 16 inches. Advantageously, the standoffs 46 permit the housing 40 to accommodate displays of various sizes from different manufacturers.

The display 5 typically has a periphery or frame outside the screen area, with a width in a range between 0.5 to 1.0 inch. This dimension may vary from screen-to-screen and manufacturer-to-manufacturer. The housing 40 includes a display opening 48, or cutout, which matches the periphery and provides a mask for the display 5. Different configurations of the display opening 48 can suitably accommodate and mask different screens from different manufacturers.

The housing 40 has a mating edge 50 which is shaped to mate with the support surface to form a continuous housing cover over the bracket 10 and the display 5. The shape of the edge 50 can be any shape to match its supporting surface, such as the ceiling panel 60. The edge 50 is suitably curved to match the curve of the ceiling panel 60. In different embodiments, the edge 50 may have penetrations to match the ceiling panel 60, to provide access for maintainence or repairs, or to accommodate wiring.

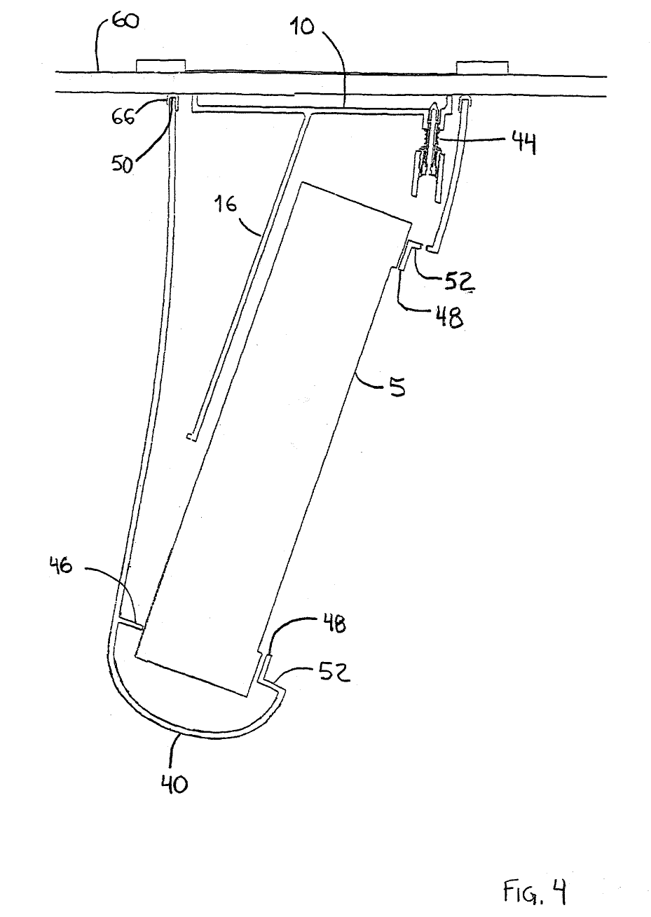

Referring now to FIG. 4, the support bracket 10, the display 5, and the housing 40, are fastened to the aircraft-ceiling panel 60. The housing 40 has a curved bottom that provides a rounded surface in the event a passer-by brushes against or hits the housing 40. The second cross member 16 provides additional support for the display 5. The forward housing fastener 44 holds the housing 40 up against the ceiling panel 60. The edge 50 of the housing 40 mates and rests against the ceiling panel 60. The ceiling panel 60 suitably has a mating rim 66 to hold and support the edge 50 of the housing 40. The fastener 44 is suitably a quick release pin and is shown in more detail in FIG. 7.

FIG. 4 shows the shape of the housing 40 in greater detail. The standoff 46 rests against the bottom of the back of the display 5 to help prevent passers-by or objects from pushing against and possibly deforming the housing 40 or the display 5. The housing 40 contains a display inset 52, which is suitably sized to place the display opening 48 to within approximately 0.1 of an inch of the front surface of the display 5. Advantageously, a number of sizes and thicknesses of various displays may be accommodated by the housing 40 by suitably sizing the standoff 46, the inset 52, and the opening 48. A rounded, sloped or multi-stepped shape suitably may be utilized for the inset 52. This permits the housing 40 to be trimmed after it has been molded to match different display sizes and display thicknesses. If a rounded or sloped inset 52 is used, different trimming changes both the size of the opening 48 and the thickness of the display 5 that can be covered by the housing 40. In an alternate embodiment, the housing 40 can be molded without an opening 48, but with a flat surface (not shown) in place of the opening. After manufacture the surface (not shown) may be cut to any size or shape within the inset 52 to match the shape and size of the displays. Trimming the housing 40 after manufacture allows a single housing 40 to be used to cover a plurality of display types without changing the manufacturing moldings for the housing 40.

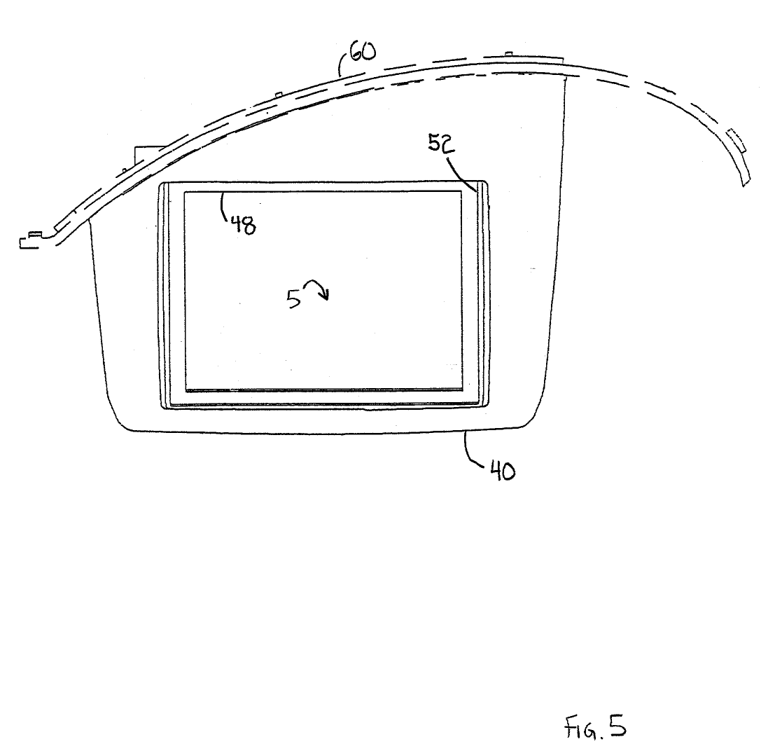

FIG. 5 shows one preferred embodiment of the present invention viewed towards the front of the display 5 with the housing 40 installed. The housing 40 covers and encloses the display 5 and the support bracket 10 (not shown), and mates against and conforms with the ceiling panel 60 of an aircraft passenger cabin. The display opening 48 of housing 40 is sized to match the display 5. The display inset 52 offsets the opening 48 within close proximity of the display 5. The combination of the inset 52, and the opening 48 form a mask that is shaped to surround the visual display area of the displays, and visually surrounds the visual display area of the display 5.

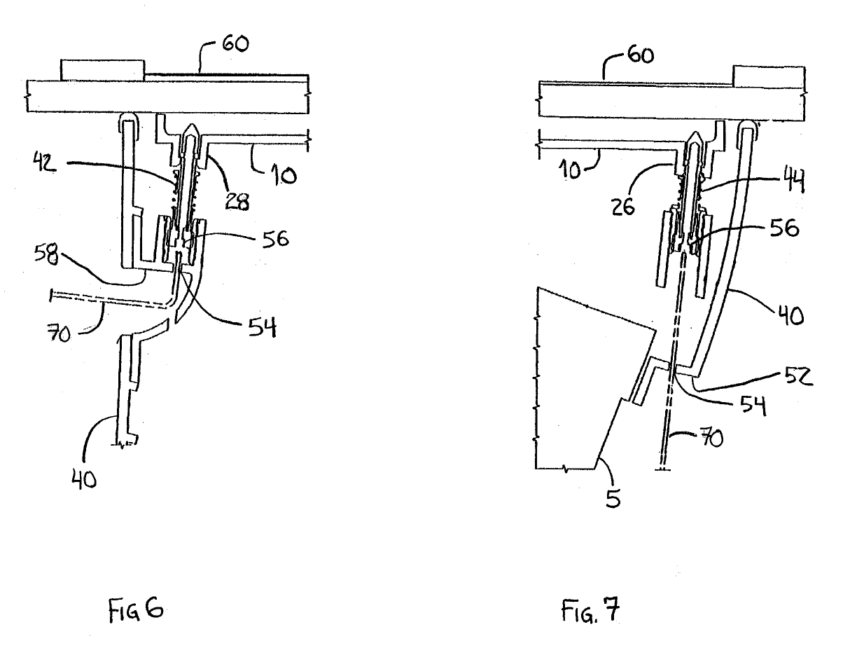

FIGS. 6 and 7 show in detail recessed, quick-release pins that fasten the housing 40 to the bracket 10. FIG. 6 is a detailed cross section of a recessed fastener supporting the back of the housing 40, while FIG. 7 is a detailed cross section of a hidden fastener supporting the front of the housing 40.

Referring now to FIG. 6, the fastener 42 connects the housing 40 to a fastener socket 28. The fastener 42 is recessed in a recess 58. This leaves a flush, rear surface to the housing 40. The recess 58 defines a tool access hole 54 which permits a suitable housing mounting tool 70 to connect with or be inserted into the fastener 42. The fastener 42 advantageously defines a socket 56 or other suitably shaped opening or slot for activating or rotating the fastener 42. The fastener 42 is suitably a quick-release pin with a built-in spring. The fastener 42 may be connected to and disconnected from the socket 28 through either a push or a short turn of the tool 70.

Referring now to FIG. 7, the fastener 44 suitably uses a quick release fastener. The fastener 44 is suitably a quick-release pin with a spring mechanism. This permits easy attachment and detachment of the housing 40 from the bracket 10. The fastener 44 is accessed through the tool access hole 54 that is recessed in the inset 52. This configuration permits the fastener 44 to be concealed and yet accessible, while allowing the front of the housing 40 to be smooth and unobstructed by any fastener heads or connections. The fastener 44 may be attached or detached utilizing the tool 70 that mates with the socket 56 or other suitable opening in the fastener 44. In a present embodiment of the invention, the tool 70 is an Allen wrench or similar tool, and the socket 56 is a hexagonal socket.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. An apparatus for supporting a display device, the apparatus comprising:
a bracket arranged to attachably receive a display device mountable thereon; and
a housing that is removably fastenable to the bracket, the housing being arranged to surround the bracket and defining a window, a visual display area of the display device being viewable within the window.

2. The apparatus of claim 1, wherein the bracket includes:
first and second substantially parallel arms arranged to receive sides of a display device therebetween for attachment thereto;
a first cross member interposed between the first and second arms; and
a second cross member interposed between the first and second arms and extending from the first cross member, the second cross member being arranged to receive a back plane of the display device for attachment thereto.

3. The apparatus of claim 2, wherein:
the first and second parallel arms are arranged to attach to sides of the display device such that a plane of a visual display area of the display device tilts downward from vertical at an angle between 10 and 20 degrees.

4. The apparatus of claim 1, wherein the bracket includes:
first and second substantially parallel arms arranged to receive sides of a display device therebetween for attachment thereto; and
a first cross member interposed between the first and second arms.

5. The apparatus of claim 4, wherein:
the first and second parallel arms are arranged to attach to sides of the display device such that a plane of a visual display area of the display device tilts downward from vertical at an angle between 10 and 20 degrees.

6. The apparatus of claim 1, wherein:
the housing is attached to the bracket with a plurality of quick-release fasteners.

7. The apparatus of claim 1, wherein:
the housing is further arranged to define a plurality of windows for viewing a plurality of different visual display areas therethrough.

8. The apparatus of claim 1, further comprising:
one or more spacers arranged to attach to the bracket and to attachably receive the display device mountable thereon.

9. An apparatus for supporting a display device, the apparatus comprising:
a bracket including:
first and second substantially parallel arms arranged to receive sides of a display device therebetween for attachment thereto, the first and second parallel arms being arranged to attach to sides of a display device such that a plane of a visual display area of the display device tilts downward from vertical at an angle between 10 and 20 degrees;
a first cross member interposed between the first and second arms; and
a second cross member interposed between the first and second arms and extending from the first cross member, the second cross member being arranged to receive a back plane of the display device for attachment thereto; and
a housing that is removably fastenable to the bracket, the housing being arranged to surround the bracket and defining a window, a visual display area of the display device being viewable within the window, the housing being further arranged to define a plurality of windows for viewing a plurality of different visual display areas therethrough.

10. The apparatus of claim 9, wherein:
the housing being attachable to the bracket with a plurality of quick release fasteners.

11. The apparatus of claim 9, further comprising:
at least one spacer arranged to attach to the bracket and to attachably receive the display device mountable thereon.

12. An aircraft visual display system comprising:
a display device;
a bracket attached to the display device mountable thereon; and
a housing removably fastenable to the bracket, the housing being arranged to surround the bracket and defining a window, a visual display area of the display device being viewable within the window

13. The system of claim 12, wherein the bracket includes:
first and second substantially parallel arms arranged to receive sides of a display device therebetween for attachment thereto;
a first cross member interposed between the first and second arms; and
a second cross member interposed between the first and second arms and extending from the first cross member, the second cross member being arranged to receive a back plane of the display device for attachment thereto.

14. The system of claim 13, wherein:
the first and second parallel arms are arranged to attach to sides of the display device such that a plane of a visual display area of the display device tilts downward from vertical at an angle between 10 and 20 degrees.

15. The system of claim 12, wherein the bracket includes:
first and second substantially parallel arms arranged to receive sides of a display device therebetween for attachment thereto; and
a first cross member interposed between the first and second arms.

16. The system of claim 15, wherein:
the first and second parallel arms are arranged to attach to sides of the display device such that a plane of a visual display area of the display device tilts downward from vertical at an angle between 10 and 20 degrees.

17. The system of claim 12, wherein:
the housing is attached to the bracket with a plurality of quick-release fasteners.

18. The system of claim 12, wherein:
the housing is further arranged to define a plurality of windows for viewing a plurality of different visual display areas therethrough.

19. The system of claim 12, further comprising:
at least one spacer arranged to attach to the bracket and to attachably receive the display device mountable thereon.
